(19) United States
(12) Patent Application Publication
(10) Pub. No.: US 2023/0126855 A1
(43) Pub. Date: Apr. 27, 2023

(54) OMNICHANNEL SYSTEM AND A METHOD FOR PROVIDING FINANCIAL AND BANK SERVICES

(71) Applicants: Monashov Serhii Yevhenovych, Kyiv (UA); Yakibchuk Myroslav Illych, Kyiv (UA); Fred M Mosely, Solon, OH (US)

(72) Inventors: Monashov Serhii Yevhenovych, Kyiv (UA); Yakibchuk Myroslav Illych, Kyiv (UA); Fred M Mosely, Solon, OH (US)

(21) Appl. No.: 17/660,742

(22) Filed: Apr. 26, 2022

(30) Foreign Application Priority Data
Oct. 26, 2021 (UA) A 2021 06003

(51) Int. Cl. G06Q 40/02; G06Q 20/10; G06Q 20/40

(52) U.S. Cl. CPC G06Q 40/02; G06Q 20/108; G06Q 20/40

(57) ABSTRACT

A group of inventions relates to an omnichannel system for providing financial and/or bank services, the system comprises a universal physical device for an interactive interaction between a client and at least two financial and/or bank services providers, and a method for providing financial and/or bank services using said system, and which enable to provide an end user with a wide range of the financial and/or bank services within a single interface window on a single peripheral device by using algorithms for processing, filtering, and identifying a client request to the single omnichannel system from all financial and/or bank services providers coupled thereto with the corresponding services and provide an alternative during selection of a certain provider when receiving the above-mentioned service without a need in conduction of a re-identification of the user, thereby facilitating and accelerating the process of providing bank and/or financial services in general.

### CROSS-REFERENCE TO RELATED APPLICATION

This application claims priority to Ukrainian Application No. a 2021 06003, filed Oct. 26, 2021, which is hereby incorporated by reference in its entirety.

### FIELD OF THE INVENTION

A group of inventions relates to a field of information technologies, particularly to an omnichannel system and a method for providing a user with financial and/or bank services using a universal physical device for an interactive interaction between a client and at least two financial and/or bank services providers.

### PRIOR ART

In a modern digital world, it becomes more difficult for banks to service clients and to maintain their competitiveness. Reasons for this are associated with a behavioral model of a younger generation that largely differs from an average consumption scenario of older generations—modern customers are more progressive from a technological perspective, they actively use digital communication channels such as messengers, chat bots etc., they are more demanding in terms of own comfort, and they will not stand in a line to receive a certain service. Furthermore, the customers require a special, personalized attitude to them.

In order to simplify and accelerate a conduction of many financial operations, devices for cash transactions automatic processing are widely spread, e.g., cash machines or ATMs, which provide financial self-services without participation of bank employees, thereby avoiding human factor-associated errors such as unintentional errors made by cashiers, malversation or thefts. The ATMs support such functions as cash withdrawal, requesting a deposit balance, money transfer between accounts, requesting a balance etc., and they also may provide deposits in cash, check deposits, and intermediary services. Card owners may use credit or savings cards to process an automated cash withdrawal, requesting a balance, transfers, cash depositing, password change, and paying bills for mobile phones on the basis of their passwords. At the same time, an essential drawback of using the ATMs lies in that usually they are mounted, used, and operated by a single defined bank services supplier that, from one hand, requires the bank to perform regular money contributions, labor and material resources to maintain and to operate the ATM, while, from another hand, it is inconvenient for a user, since it enables the latter to fully use the services of one bank only, while a need to use services of another bank services supplier is associated with additional expenses for processing a procedure of conduction of a transaction by a third party.

Nowadays, a development of systems for “bank-client” interaction is directed to a maximum simplification of an access to the services of any bank via any online mechanism, as well as by means of universal self-service complexes.

Prior art teaches systems and methods for providing a user with financial and/or bank services involving several providers, and the inventor has selected several technical solutions therefrom, which are the closest to the proposed group of inventions in terms of a set of essential features.

So, a U.S. Pat. No. 10,956,971B2 dated Mar. 23, 2021 teaches systems and methods for switching electronic accounts by means of a self-service device. The system for switching electronic accounts receives, from the self-service device, a request for switching an existing electronic account that is associated with a first financial services provider to a new electronic account that is associated with a second financial services provider, as well as it receives an information that is associated with the existing electronic account and generates the new electronic account that is associated with the second financial services account, and transmits a data such as money associated with the existing electronic account to the new electronic account. Also, the system for switching electronic accounts may send an information that is associated with the new electronic account to the self-service device, while the self-service device may provide the client with a new, ready-to-use card that is associated with the new electronic account. A drawback of the proposed technical solution lies in a narrow field of its use that is limited only by an option of switching the existing electronic account that is associated with the first financial services provider to the new electronic account that is associated with the second financial services provider, as well as in a fact that not more than two financial services providers may participate in the process.

An application CN109246188A dated Jan. 18, 2019 teaches a system for supporting multi-channel transactions and a method for processing thereof. The multi-channel transactions systems comprise a communication sub-system and a services processing sub-system, wherein the communication sub-system is coupled to a transactions channel, and the services processing sub-system is coupled to a bank services system. The communication sub-system receives a transaction request message sent by the transaction channel and performs a conversion of its format, then the services processing sub-system transmits the transaction request message to the bank services system that corresponds to the transaction service in the transaction request message for further processing. The system may receive an information regarding the transactions requests from several trade channels and provides a communication between different trade channels and the bank services system. Therewith, the transaction channel may be an ATM or a trading complex POS or a mobile terminal that corresponds to a mobile banking; the bank system includes a UnionPay system, a credit cards system of each bank, and a debit system of each bank card or an electronic money accounts system of each bank. The proposed technical solution discloses a kind of a trading floor for clients and providers of certain services and/or goods, and, after a data of an order of services and/or goods proposed to the client are processed, the multi-channel system determines the best payment or money receipt method for the services and/or goods rendered. A drawback of the proposed technical solution lies in a multi-channel nature of the performed transactions that lies in use of different independent communication channels for interaction with the clients, thereby making it impossible, e.g., to collect general statistics and an information regarding prevailed sort of a target group and a type of transaction requests. Furthermore, when using the multi-channel transactions processing system, the client must pass identification and personal data verification each time during interaction with a new transaction channel, thereby significantly complicating the transactions conduction process and making it more inconvenient for the user.

An automatic cash operations processing system and method according to an application CN105719406A dated Jun. 29, 2016 is taken as the closest analogue of the groups of inventions, according to which, at a first device that is a cash operations processing terminal, a user is provided with a plurality of bank marks for selection, wherein each bank mark can be selected by the user to determine a communication channel between the first device and a bank that corresponds to the selected bank mark; determining the communication channel between the corresponding bank and the first device in response to the bank selection operation of the user; receiving an account information and user identification information, and transmitting the information to a server of the selected bank via the determined communication channel; transmitting a transaction data to the server of the selected bank by the first device, thereby allowing conduction of the transaction operation by the user, via the determined communication channel; returning a transaction operation result by the first device to the user according to a return message receiving after updating the user account based on the transaction data by the server of the selected bank. According to the method disclosed by the invention, when holding an intelligent card of a certain bank, the user can select a channel corresponding to the bank in order to perform a direct cash transaction processing on the same device instead of transferring the transaction through a third party, particularly for such transactions as cash withdrawal, money transfer, and remittance of the account. According to the claimed invention, the bank mark is a graphical interactive user interface object to be interacted with by the user to determine the selected bank communication channel, wherein the bank mark is the user-selectable object, and this object is linked to a corresponding internal bank application and is transmitted therethrough. As in the previous case, the proposed technical solution is characterized by a multi-channel nature that lies in use of different independent communication channels between the terminal and different bank services providers, with a main drawback that lies in a kind of a dialog break and in that the system is not capable of performing an automated verification of availability of a certain communication channel. Therewith, the communication between the client and the banks is carried out via separate bank applications, rather than via an integrated system, thereby significantly narrowing both a number of available bank services providers, since only rather large banks may afford a rather large spectrum of operations within their application, and a number of available operations which mainly represent operations as to account funding, cash withdrawal, money transfer between cards. Furthermore, use of the cash operations processing system will be possible only if the client possesses the smart card of the defined bank, thereby limiting the use of the claimed technical solution only by those users who possess this card that acts as a kind of an identifier that the client belongs to the bank that issued this card.

### SUMMARY OF THE INVENTION

The claimed group of inventions is based on a task to develop a safe, due to exclusion of a human-factor influence, simple and easy to use, 24/7 available omnichannel system for providing financial and/or bank services in a form of at least one universal, reliable, portable, easy and convenient to use, physical device for client's interactive interaction with at least two financial and/or bank services providers in a form of a software and hardware complex (SHC) or ATM that may be mounted at any location and in conditions of a limited space, and a method for providing financial and/or bank services using said system, and which enable to achieve a technical effect that lies in providing an end user with a wide range of the financial and/or bank services within a single interface window on a single peripheral device by using algorithms for processing, filtering, and identifying a client request to the single omnichannel system from all financial and/or bank services providers coupled thereto with the corresponding services and providing an alternative during selection of a certain provider when receiving the above-mentioned service without a need in conduction of a re-identification of the user, which is implemented due to saving a history and by means of a statistical data processing by the system as to operations earlier conducted by the client, thereby, in turn, assisting in facilitating and accelerating the process of providing bank and/or financial services in general.

In a first aspect, the posed task is resolved due to the fact that the omnichannel system for providing financial and/or bank services comprises the universal physical device for the client's interactive interaction with at least two financial and/or bank services providers, the device comprises:

an automated identification unit that is a client identification system that is integrated with one of the financial services providers, the unit comprises user identification based on a contactless reading (NFC) and/or a bank card reading and/or a phone number (MSISDN) inputting. The user identification based on the NFC contactless reading lies in that the client puts a phone, a watch and another NFC technology-equipped electronic device to a contactless reader that is embedded into the self-service complex, having preliminary activated the APPLE PAY or GOOGLE PAY system with the bank card on the electronic device linked thereto. This identification method is the quickest one among all the listed methods, and it does not require inputting the card number on a screen, thereby ensuring a personal data safety. The identification based on the bank card reading implies that the client puts the bank card that supports the NFC to the contactless NFC-reader on the self-service complex or inserts it with a magnetic strip or chip into a reader embedded into a housing of the complex or inputs the card number on the screen of the complex manually. An advantage of this method lies in enabling the identification in case when the complex and/or the card are/is not equipped with the NFC technology or even if the bank card is absent under the proviso that the client knows its number. The identification based on the phone number implies inputting the same manually in a special window on the screen which is characterized by reliability and simplicity of conduction. According to the proposed invention, the client is enabled to perform a selection from at least two above-mentioned identification methods on their own, and thereafter the system will perform the automatic client identification;

a database of coupled and/or registered financial and/or bank services providers. If it is not possible to find the required provider in the database of the couple and/or registered providers, and, thus, to perform the client automated identification, the latter will be enabled to select the financial and/or bank services provider manually on their own from the list on the SHC or ATM screen;

an integration omnichannel module that is integrated with at least two service channels of the at least two financial and/or bank services providers. According to the proposed invention, main service channels are as follows: currency exchange and/or ATM services and/or international transfers and/or payment systems services and/or emission of bank cards and/or smart contracts. According to the proposed invention, the currency exchange service channel implies performing a multi-transactional exchange of a wide range of currencies, namely, cash, cashless, and digital cryptocurrency money into different types of the currency, without limitation to a bidirectional exchange only, enabling a payment according to the types of exchange by means of cash, cashless, and mixed payment types. The ATM services imply cash withdrawal, depositing cash to account, review of a bank card balance, a PIN code modification etc. The system also implies conducting at least one of such international transfers as MoneyGram, Ria, Unistream, Western Union, although any other type of the international transfers may be performed without falling beyond the concepts of the present invention. The payment system services include funding C2C cards, bills payments according to bank details or via a QR-code, a mobile connection payment, a self-collection for legal entities and private entrepreneurs, although they are not limited by the mentioned examples. The emission of bank cards implies an issuance of a card of any type such as debit card, credit card or an overdraft card of any payment system, e.g., Visa, MasterCard, MIR or NSMEP, having a magnetic strip, a chip or a contactless which meet the standards ISO 7811, ISO 7816, ISO 14443. It should be appreciated that the issuance of a card of any other type is possible without falling beyond the concepts of the present invention. In order to provide the emission of cards, the universal physical interactive interaction device is equipped with at least two boxes each having a capacity of 300 cards. An average duration of the card emission is 20-40 seconds, after the card is issued, the bank may link a certain loyalty, microcredit or overdraft program thereto during a short time period after the client personal data has been processed. It should be appreciated that the above-mentioned services channels which are provided by the financial and/or bank services providers are used merely as illustrations of possible embodiments of the invention, and any other potentially possible types of the service channels which are provided in the field of the financial and/or bank services may be used without falling beyond the concepts of the present invention;

a united integration platform for coupling the integration omnichannel module to the at least two financial and/or bank services providers via the protocol ISO 8583 with a processing center and/or via a request to an automated bank system (ABS) of the financial services provider via a secured communication channel or via an API protocol, and which interacts with the omnichannel module via a REST API protocol. Advantages of coupling via the processing center PC that is oriented to couple ATM and complex equipment lie in that the data is transferred in real time according to specialized international protocols, thereby providing a maximum safety level, while special commands and statuses enable to perform a detailed monitoring of a technical condition of the coupled equipment and a transaction status at any step. A request to the ABS that is a bank software that provides an exchange of messages of arbitrary format with the bank enables to expand a type of the bank operations significantly, which are performed by means of the ATM, as well as it enables to perform operations offline during a bank day. The API of the bank and/or financial services providers, which is a constituent part of XML or JSON and provides the coupling by means of Internet connection, provides data in real time, thus, it is always actual and perfectly accurate. Furthermore, the API makes available many financial services offline, which are not supported by a standard bank software PC and ABS (e.g., operations with cryptocurrencies, international money transfer systems);

a software and hardware unit that includes activation of at least two external features of the bank and/or financial services providers by means of lighting and/or video and/or LED indication. The external features of the bank and/or financial services providers include a logo and/or a trademark and/or corporate colors, although they are not limited thereto and use of any other external features is possible without falling beyond the concepts of the present invention.

In another aspect, the present invention provides a method for providing financial and/or bank services that is performed in several steps:

a step of automated user identification by means of an automated identification unit that is a client identification system that is integrated with one of the financial and/or bank services providers, the unit comprises user identification based on a contactless reading (NFC) and/or a bank card reading and/or a phone number (MSISDN) inputting. Therewith, the client is enabled to perform a selection from at least two possible identifiers, afterwards the system will automatically select the provider which this identification relates to;

a step of verifying an availability of the financial and/or bank services providers coupled to the system. If it is not possible to find the required provider in the database of the couple and/or registered providers, and, thus, to perform the client automated identification, the latter will be enabled to select the financial and/or bank services provider manually on their own from the list on the SHC or ATM screen;

a step of selecting, from at least two available service channels, at least two financial and/or bank services providers integrated with the integration omnichannel module. According to the proposed invention, main service channels are as follows: currency exchange and/or ATM services and/or international transfers and/or payment systems services and/or emission of bank cards and/or smart contracts, although use of other services channels is possible without falling beyond the concepts of the present invention. Therewith, in case the service among the selected/requested by the client is failed or absent in the selected bank and/or financial services provider, the client will be suggested to return to the main screen or to receive the required service from another bank and/or financial services provider without returning to the main screen of the complex which does not require a re-identification of the client and significantly accelerates and facilitates the process of receiving of the defined service by the client;

a step of activating a profile of the bank and/or financial services provider relative to the service channel selected at the previous step by means of a direct coupling of the united integration platform that interacts with the omnichannel module via a REST API protocol to external bank services via a ISO 8583 protocol with a processing center and/or via a request to an automated bank system (ABS) of the bank and/or financial services provider via a secured communication channel or via an API protocol;

a step of activating at least two external features of the bank and/or financial services providers by means of lighting and/or video and/or LED indication. The external features of the bank and/or financial services providers include a logo and/or a trademark and/or corporate colors, although they are not limited thereto and use of any other external features is possible without falling beyond the concepts of the present invention.

### BRIEF DESCRIPTION OF THE DRAWINGS

An exemplary embodiment of the system and method, according to the group of inventions, is illustrated by the drawings, which depict the following:

FIG. 1 illustrates main elements of the omnichannel system for providing financial and/or bank services by means of the universal physical device for the interactive interaction between the client and at least two financial and/or bank services providers, the devices is in the form of the SHC, and the algorithm for performing the method for providing financial and/or bank services using said system.

FIG. 2 illustrates main elements of the integration omnichannel module that is integrated with services channels of ten financial and/or bank services providers.

FIG. 3 schematically depicts a structure of the physical device for the interactive interaction between the client and ten financial and/or bank services providers in a form of an interactive ATM and a digital component of such interaction.

### IMPLEMENTATION OF THE GROUP OF INVENTIONS

The group of inventions is implemented in several embodiments according to the examples mentioned below.

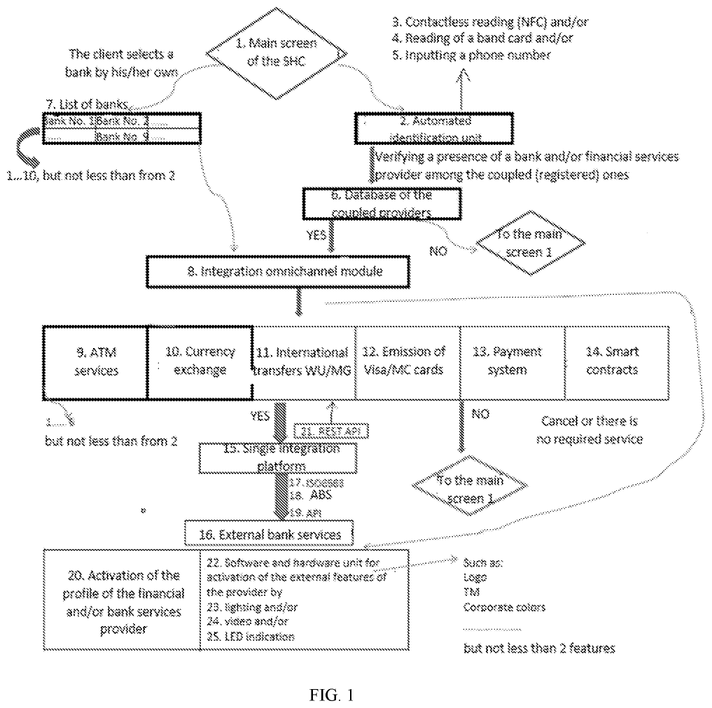

FIG. 1 illustrates main elements of an omnichannel system for providing financial and/or bank services by means of a single interface window of a main screen 1 of a universal physical SHC device for an interactive interaction between the client and at least two financial and/or bank services providers, the device comprises a client automated identification unit 2 that is a client identification system that is integrated with one of financial and/or bank services providers and includes an identification of a user based on NFC 3 and/or reading a bank card 4 and/or inputting a phone number MSISDN 5. According to the proposed invention, the client performs a selection from at least two above-described identification methods on their own, and thereafter the system performs an automatic verification of whether this provider is present among those coupled and/or registered in a database 6 of the coupled providers and performs the client automated identification. If it is not possible to perform the automated identification due to an absence of the bank and/or financial services provider among those coupled and/or registered in the database 6, the user will select the bank manually from a list 7 on the screen 1 that comprises from two to six bank and/or financial services providers. Upon conduction of the client automated identification in the automated identification unit 2 or upon the client's own manual selection of the bank from the list 7 on the screen 1, the system moves to a step of selecting, from at least two available services channels, at least two financial and/or bank services providers which are integrated with an integration omnichannel module 8, including ATM services 9 and/or currency exchange 10 and/or international transfers 11 and/or emission of bank cards 12 and/or payment systems services 13 and/or smart contracts 14, although it should be appreciated that any other types of service channels which are provided in the field of financial and/or bank services may be used without falling beyond the concepts of the present invention. Therewith, in case of failure or absence of the service among the bank and/or financial services in the requested provider as selected/requested by the client, the client will be suggested to return to the main screen 1 or to receive the required service in another bank and/or financial services provider without returning to the main screen 1 of the complex, which does not require any re-identification of the client and significantly accelerates and facilitates the process of receiving said service by the client. Upon selection of the available service channel by the client, the system will activate 20 a profile of the bank and/or financial services provider that provides this service by means of a direct coupling of a single integration platform 15 of the integration omnichannel module 8 to external bank services 16 via ISO 8583 protocol with a processing center 17 and/or via a request to an ABS 18 of the bank and/or financial services provider via a secured communication channel or via an API protocol 19. Therewith, the single integration platform 15 interacts with the omnichannel module 8 having the integrated service channels via a REST API protocol 21. In order to facilitate the user's own manual selection of the bank and/or financial services provider on the main screen 1 due to their visualization, the system comprises a software and hardware unit 22 that comprises activation of at least two external features of the bank and/or financial services providers by means of a lighting 23 and/or video 24 and/or LED 25 indication. The external features of the bank and/or financial services providers include a logo and/or a trademark and/or corporate colors, although they are not limited thereto and use of any other external features is possible without falling beyond the concepts of the present invention.

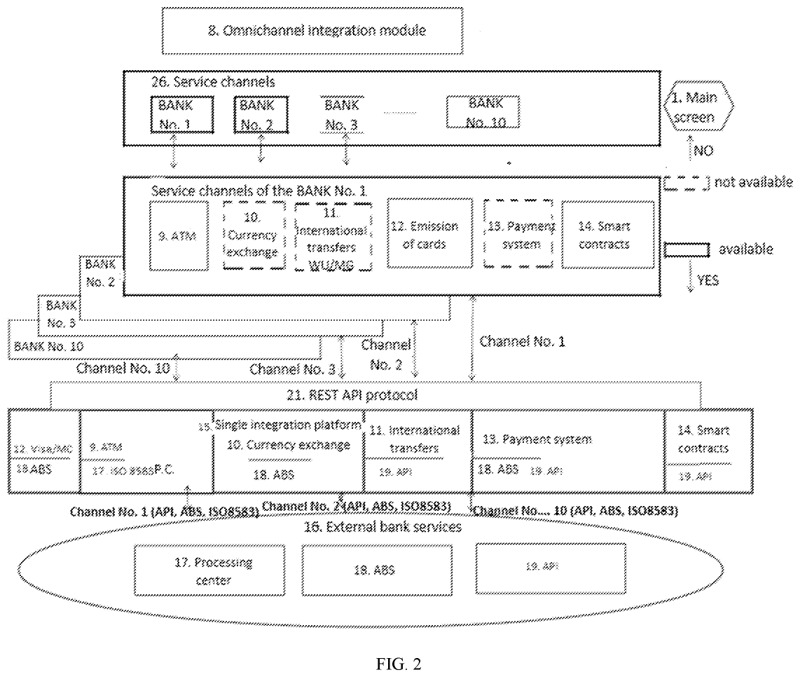

FIG. 2 illustrates an exemplary embodiment of the integration omnichannel module 8 that is integrated with services channels 26 of each of the ten financial and/or bank services providers. According to the proposed scheme, the integration omnichannel module 8 is integrated with the service channels of each of the ten financial and/or bank services providers such as Bank No. 1, Bank No. 2, . . . , Bank No. 10 as depicted in FIG. 2, which include the ATM services 8 and/or the currency exchange 10 and/or international transfers 11 and/or emission of bank cards 12 and/or payment systems services 13 and/or smart contracts 14. Therewith, in case the service among the selected/requested by the client is absent in the selected bank and/or financial services provider, the client will be suggested to return to the main screen 1 or to receive the required service from another bank and/or financial services provider without returning to the main screen 1 of the complex which does not require a re-identification of the client and significantly accelerates and facilitates the process of receiving of the defined service by the client. Upon selection of the available service channel, e.g., a channel No. 1 for the Bank No. 1, a channel No. 2 for the Bank No. 2, a channel No. 3 for the Bank No. 3 or a channel No. 10 for the Bank No. 10, by the client, the system will activate a profile of the bank and/or financial services provider that provides this service by means of a direct coupling of the single integration platform 15 of the integration omnichannel module 8 to external bank services 16 via the processing center 17 and/or via a request to the ABS 18 of the bank and/or financial services provider via a secured communication channel or via the API protocol 19. Therewith, the single integration platform 15 interacts with the omnichannel module 8 having the integrated service channels via a REST API protocol 21. Thus, according to the proposed scheme, the services of emission of Visa/MC bank cards 12 and the currency exchange services 10 are provided by means of the direct coupling of the single integration platform 15 of the integration omnichannel module 8 to the external bank services 16 via the request to the ABS 18 of the bank and/or financial services provider via the secured communication channel, the ATM service 9—via the ISO 8583 protocol with the processing center PC 17, the international transfers 11 and the smart contracts 14 services—via the API protocol 19, the payment systems services 13—via the request to the ABS 18 of the bank and/or financial services provider and/or via the API protocol 19. Therewith, it should be appreciated that any other types of the service channels which are provided in the field of the financial and/or bank services may be used without falling beyond the concepts of the present invention.

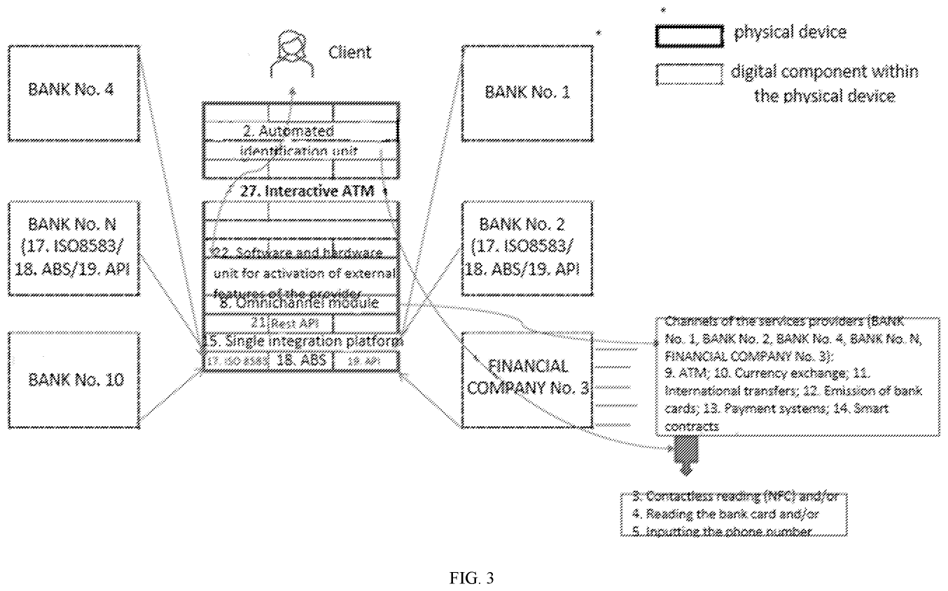

FIG. 3 schematically illustrates a structure of the physical device for the interactive interaction between the client and ten financial and/or bank services providers in a form of an interactive ATM 27 and a digital component of such interaction. According to the described scheme, the omnichannel system comprises a modern, technologically complete, new-generation physical device in a form of the interactive ATM 27 that is essentially a floor for arrangement of up to ten financial and/or bank services providers therein, such as BANK No. 1, BANK No. 2, FINANCIAL COMPANY No. 3, BANK No. 4 . . . , BANK No. 10, in a form of their digital presence by means of a software integration of said providers with the omnichannel system 8 via the processing center 17 and/or via the request to the ABS 18 of the bank and/or financial services provider via the secured communication channel or via the API protocol 19 owing to the internal single integration platform 15 that interacts with the omnichannel module 8 and, thus, with other elements of the omnichannel system via the REST API protocol 21. The principle of such interaction is based on the omnichannel nature, thereby enabling to save, at various steps of performing operations with the client, its interaction history with the system and to switch the same between the service channels and the bank and/or financial services providers which provide these services. The main service channels which are integrated with the omnichannel module 8 are the ATM services 9 and/or the currency exchange 10 and/or international transfers 11 and/or emission of bank cards 12 and/or payment systems 13 and/or smart contracts 14, although they are not limited thereto and any other service channels may be used without falling beyond the concepts of the present invention. The physical implementation of the omnichannel system for providing financial and/or bank services is performed owing to the fact that the interactive ATM 27 comprises the client automated identification unit 2, which includes the identification based on the contactless reading NFC 3 and/or reading of the bank card 4 and/or inputting the phone number MSISDN 5, and the software and hardware unit 22, which includes the activation of at least two external features of the bank and/or financial services providers by means of the lighting and/or video and/or LED indication. The external features of the bank and/or financial services providers, which create a maximum recognition of a certain provider by its clients, include a logo and/or a trademark and/or corporate colors, although they are not limited thereto and use of any other external features is possible without falling beyond the concepts of the present invention.

Therefore, the proposed group of inventions enables to provide the user with a wide range of bank and/or financial services within the single interface window at the single peripheral device by using the algorithms for processing, filtering, and identifying the client request to the single integration omnichannel system from all financial and/or bank services providers coupled thereto with the corresponding services and providing the alternative during selection of a certain provider when receiving the above-mentioned service without a need in conduction of a re-identification of the user, which is implemented due to saving the history and by means of the statistical data processing by the system as to operations earlier conducted by the client, thereby, in turn, assisting in facilitating and accelerating the process of providing bank and/or financial services in general.

It should be noted that the above-described embodiments of the group of inventions should be used as an illustration only and shall not limit the scope thereof. Obvious modifications of embodiments of the group of inventions may be easily made by persons skilled in this field of art without going beyond the essence thereof.

1. An omnichannel system for providing financial and/or bank services, the system comprising a universal physical device for a client's interactive interaction with at least two financial and/or bank services providers, the device comprising:
an automated client identification unit that is a client identification system that is configured to be integrated with one of the financial and/or bank services providers, the client identification unit comprising an identification based on a contactless reading (NFC) and/or a bank card reading and/or a phone number (MSISDN) inputting;
a database of coupled and/or registered financial and/or bank services providers;
an integration omnichannel module that is configured to be integrated with at least two service channels of the at least two financial and/or bank services providers;
a united integration platform for coupling the integration omnichannel module to the at least two financial and/or bank services providers via the protocol ISO 8583 with a processing center and/or via a request to an automated bank system (ABS) of the financial and/or bank services provider via a secured communication channel or via an API protocol, and that interacts with the omnichannel module via a REST API protocol; and
a software and hardware unit configured to activate at least two external features of the financial and/or bank services providers by means of lighting and/or video and/or LED indication.

2. The omnichannel system for providing financial and/or bank services according to claim 1, characterized in that the service channels of the at least two financial and/or bank services providers are currency exchange and/or ATM services and/or international transfers and/or payment systems services and/or emission of bank cards and/or smart contracts.

3. The omnichannel system for providing financial and/or bank services according to claim 1, characterized in that the external features of the financial and/or bank services providers are a logo and/or a trademark and/or corporate colors.

4. A method for providing financial and/or bank services by means of the omnichannel system according to claim 1, the method comprising:
a step of automated client identification by means of an automated identification unit that is a client identification system that is integrated with one of the financial and/or bank services providers, the unit comprising identification based on a contactless reading (NFC) and/or a bank card reading and/or a phone number (MSISDN) inputting;
a step of verifying an availability of the financial and/or bank services providers coupled to the system;
a step of selecting, from at least two available service channels, at least two financial and/or bank services providers integrated with the integration omnichannel module;
a step of activating a profile of the financial and/or bank services provider relative to the service channel selected at the previous step by means of a direct coupling of the united integration platform that interacts with the omnichannel module via a REST API protocol to external bank services via a ISO 8583 protocol with a processing center and/or via a request to an automated bank system (ABS) of the financial and/or bank services provider via a secured communication channel or via an API protocol; and
a step of activating at least two external features of the financial and/or bank services providers by means of lighting and/or video and/or LED indication.

5. The method for providing financial and/or bank services according to claim 4, characterized in that the service channels of the at least two financial and/or bank services providers are currency exchange and/or ATM services and/or international transfers and/or payment systems services and/or emission of bank cards and/or smart contracts.

6. The method for providing financial and/or bank services according to claim 4, characterized in that the external features of the financial and/or bank services providers are a logo and/or a trademark and/or corporate colors.
